(19) United States
(12) Patent Application Publication
(10) Pub. No.: US 2019/0078980 A1
(43) Pub. Date: Mar. 14, 2019

(54) METHOD FOR PRODUCING A SAMPLE PART

(71) Applicant: Benteler Maschinenbau GmbH, Bielefeld (DE)

(72) Inventors: Heiko BIER, Herford (DE); Karsten BECKER, Bunde (DE)

(21) Appl. No.: 16/130,121

(22) Filed: Sep. 13, 2018

(30) Foreign Application Priority Data
Sep. 13, 2017 (DE) 10 2017 121 203.5

(51) Int. Cl. G01N 1/04; B26F 3/00

(52) U.S. Cl. CPC G01N 1/04; B26F 3/004

(57) ABSTRACT

A method for producing a part sample from a motor vehicle metallic welded part is disclosed having the steps of providing the metallic welded part, introducing the part into a water jet cutting device, water jet cutting a part sample section, which includes at least partially a weld seam, with the water jet cutting process being performed with sand mixed in, and removing and visually inspecting the part sample as a metallurgic micrograph.

### CROSS REFERENCE TO RELATED APPLICATION

The present application claims priority to German Patent Application Number 10 2017 121 203.5, filed Sep. 13, 2017, the disclosure of which is hereby incorporated by reference herein in its entirety.

### BACKGROUND

### 1. Field of the Invention

The disclosure is related to a method for producing a part sample made from a metallic component and, more specifically, taking a part sample of a component for quality inspection.

### 2. Description of the Related Art

In order to ensure quality in serial production and particularly in the automotive engineering, sample tests are performed. These tests are performed as part of the quality assurance. In particularly, in welded parts, the weld seams produced via automatic procedures must be checked for their quality. One way to do that is to cut the part and the seam for inspection. For this, usually a metallurgical micrograph is prepared. The metallurgical micrograph is prepared particularly in the area of the weld seam.

However, during the mechanical cutting and the separating process, thermal influencing develop which sometimes can falsify the actually given status at the part.

For example, DE 10 2011 054 866 A1 discloses generating an opening in a motor vehicle part, which is produced via water jet cutting.

### SUMMARY

According to an exemplary embodiment, the invention is embodied as to allow testing by way of sampling metallic parts in a production process and examine specific areas of part samples in a targeted fashion.

A method for the production of a part sample of a metallic component, particularly a welded part is disclosed herein the welded part used as a motor vehicle part.

According to an exemplary embodiment, a method for producing the part sample made from a metallic component used as a welded part for a motor vehicle component, comprises the following processing steps:
providing the metallic welded part,
introducing into a water jet cutting device,
water jet cutting of a section of a part sample, which includes at least partially a weld seam, with the water jet cutting process being performed with sand mixed in, and
removing and examining the part sample as a metallurgic micrograph.

According to an exemplary embodiment, a water jet cutting device and/or a device for implementing the method is also disclosed embodied as a safety cabin with a circumferential protective panel. Within this protective panel, the respective part can then be introduced and guided to the individual stations, particularly to the water jet cutting device. The water jet cutting process is performed with sand being mixed in. This is in particularly abrasive sand. This allows to sever the metallic material, particularly also metallic materials showing higher stability features. The parts, particularly motor vehicle components, represent in particular preferred chassis components, motor parts, in particular for example exhaust manifolds, instrument panel carriers, steering wheels, bumpers, as well as other chassis parts, structural components, or parts of the outer body. For example, the metallic parts may be made from steel alloys. However, parts made from light-metal alloys, or example aluminum alloys, can also be processed with the water jet cutting method according to the invention.

For the water jet cutting process a pressure of up to 600 MPa is used, applied by the water. In the cutting head of the water jet cutting device there is a water nozzle, a mixing chamber, and a focusing tube. When the water exits the water nozzle and enters the mixing chamber of a cutting head the exit velocity of the water reaches up to 1,000 m/s. Now the sand is suctioned via a vacuum into the mixing chamber. The vacuum itself can be generated by the water exiting, however it may also occur separately. The sand is then mixed to the water jet. The focusing tube then centers the jet comprising sand and water and forms an abrasive water jet. The energy of the jet is bundled and then a separating cutting can occur in a focused fashion.

The water jet cutting with abrasive sand is advantageous in that the metallic material is severed very well, while at the same time hardly any heat input, or else a negligible amount, occurs on the edge. This way it is possible to subject the part sample produced with the method according to the invention without any further mechanical treatment directly to an examination. This test may be performed via a metallurgic micrograph. The subsequent etching serves to increase the contrast and the better visual detection of the penetration at the cutting surface.

For the etching process of steel samples, for example, an Adler acid can be used, thus an etching agent according to Adler. This may comprise for example the following elements:

### Solution A:

3 g Ammonium chloro-cuprate+
25 ml distilled water

### Solution B:

15 g Iron(III)-chloride+
50 ml concentrated hydrochloric acid
After all of this has dissolved completely, add solution B into A.

This particularly refers to a macro-etching agent. For a component made from an aluminum alloy for example caustic lye of soda can be used.

The etching agent can be applied by any method, such as brushing, immersion, or spraying, particularly after the water jet cutting process and thus without any intermediate treatment.

The water jet cutting device may contain a jet annihilator on the parts opposite side or on the side located underneath the part. This jet annihilator absorbs the residual energy of the abrasive jet comprising sand and water. The jet annihilator is particularly a water basin. The jet annihilator may however also show a concentrated absorbing geometry, which moves synchronously to the motion of the abrasive water jet. The jet annihilator can therefore also be called a catcher. Within the jet annihilator, for example ceramic spheres may be arranged, which assumes the energy and distribute it.

The part samples which are dimensionally smaller can be cut out in a targeted fashion. Those part samples may have a size of less than 50 by 50 mm. Proven to be particularly advantageous, the part samples are configured with a rectangular cross-section, which show a dimension at one side from 5 to 15 mm and on the other side from 15 to 25 mm. The part samples may have a length by width of 10 by 20 mm.

As an alternative to a rectangular configuration, the part sample may be semi-circle and/or half-moon. This means it shows two cut edges, a straight cut edge as well as a rounded cutting edge. The straight cut edge serves later as the analysis surface, in order to perform the test of the metallurgic micrograph. An arched side, thus a curved cut edge, serves only for separating the part samples from the part. The two lateral and/or cut edges are severed with different cutting qualities. A particularly high quality is demanded at the straight cut edge. This means that the water jet for cutting is advanced with a slow feed rate. The arch itself is cut at a high speed. This reduces the quality at the cut edge itself. This curved and/or arched cut edge serves however only for separating the part sample so that here a clock-optimized cutting time is used.

In accordance with an exemplary embodiment, a metallic material with a sheet thickness and/or wall thickness of 0.5 to 10 mm, or 1 to 5 mm can be cut. Even parts placed in double layers next to each other can be cut relatively easily according to the invention.

Furthermore, a respective part sample is marked. For this purpose, a respective part sample, particularly a relatively small part sample, is initially left at the part after the cutting process. For this purpose, at least one bar, also called breaking bar, remains. This section is therefore not severed. This way it is possible to break out the part sample after the part has been removed. The part sample is therefore broken off at the bar and/or out of the part.

The part sample itself may be marked. For this purpose, a marking unit is provided in the device for water jet cutting. In particular, it represents a laser marking device. Before or after cutting out the part sample, a respective marking can be applied on the part sample itself and/or on the section in which the part sample is later cut out. This marking may for example show a part number, a part sample number, and/or a date. Another advantageous effect is that the marking, which is applied at the surface with a laser into the part, is not falsified or becomes illegible by the water jet cutting process. The later cut-out and/or broken out part samples can therefore be clearly identified.

Inside the water jet cutting device, for example an industrial robot may be provided, which accepts an inserted part, transfers it to the marking unit, and then moves it to the actual water jet cutting process, and after the water jet cutting process has been performed, guides it to a discharge point. The industrial robot may guide the part also under the water jet so that a respective cutting geometry is generated by the water j et. However, a separate manipulator may also be provided, which guides the water jet and/or particularly the focusing tube of the water j et, and this way generates the geometry to be cut out. Additionally, a manipulator may be provided which guides the part in reference to the water jet.

### BRIEF DESCRIPTION OF THE DRAWINGS

For an understanding of embodiments of the disclosure, reference is now made to the following description taken in conjunction with the accompanying drawings, in which:

FIG. 1 is a plan view of a water jet cutting device according to an exemplary embodiment;

FIG. 2 is a detailed view of a detail of the welded part with three side-by-side and parallel arranged part samples; and

FIG. 3 is a plan view of a part sample having a semi-circular shape and configuration.

In the figures, the same reference signs are used for identical or similar component parts, even if a repeated description is omitted for reasons of simplification.

### DETAILED DESCRIPTION OF SOME EMBODIMENTS

Some embodiments will be now described with reference to the Figures.

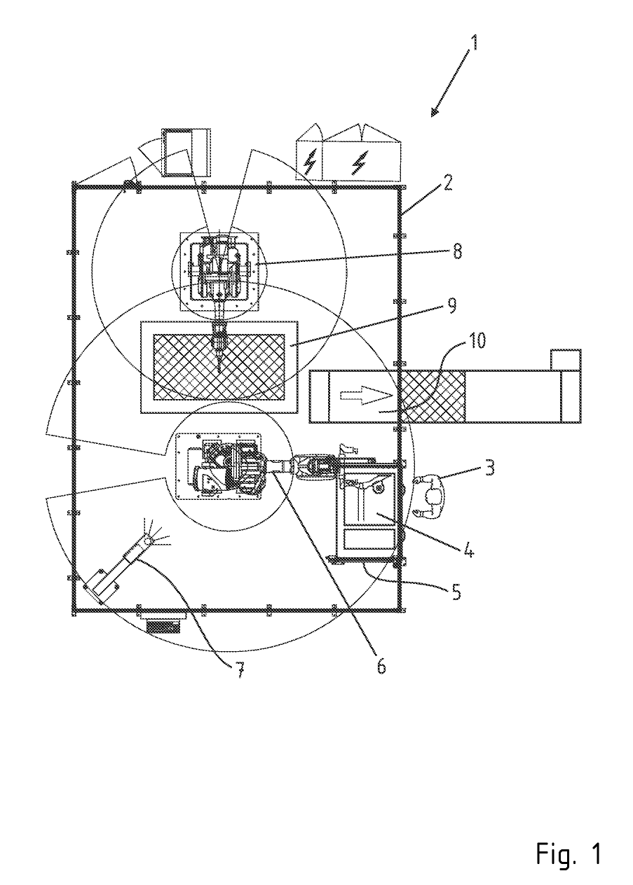

FIG. 1 shows a plan view of a water jet cutting device 1 according to an exemplary embodiment. It is surrounded by a protective panel 2, so that a technician 3 using it is located outside the water jet cutting device 1. A part 4 can be inserted in and/or transferred via a feeding of inserting device 5, for example, an exchange drawer, to the water jet cutting device 1.

An industrial robot 6 is arranged in the water jet cutting device 1, which engages the part and for example transfers it to a laser unit with a laser marking device 7. An autonomous water jet cutting device 8 is provided and a water basin 9 may be arranged underneath it during operation.

The part 4 to be cut is then arranged above the water basin 9 and the water jet cutting device 8 can be moved via a manipulator and can perform the cutting process above the water basin 9.

Moreover, a discharge device 10 is provided. The part that has been cut may be placed on the discharge device 10 and then removed from the water jet cutting device 1.

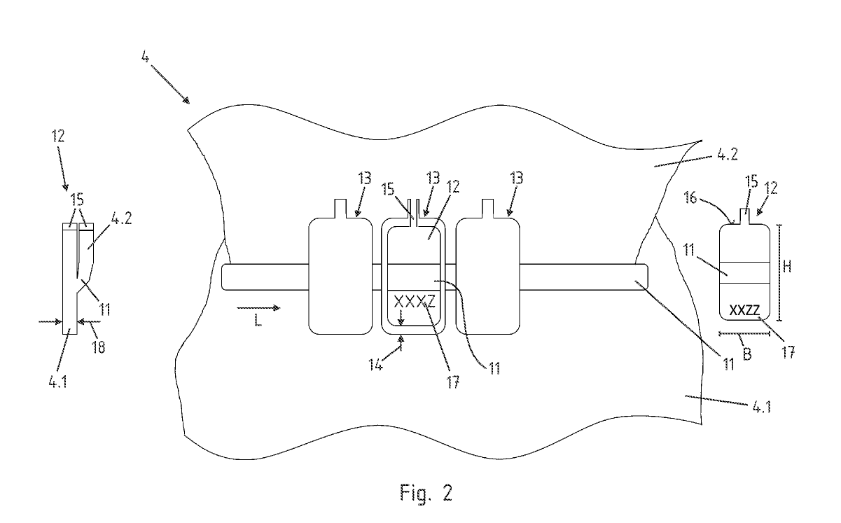

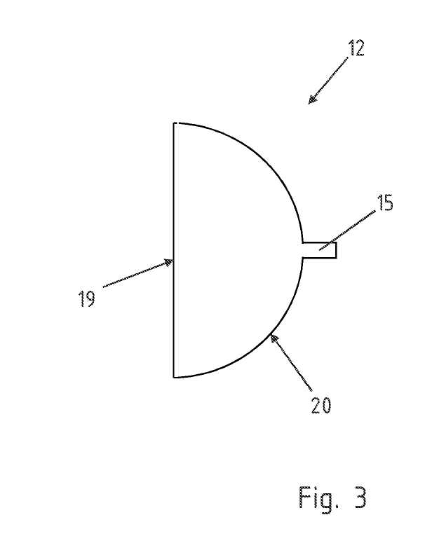

Referring to FIG. 2, a detailed configuration of the part 4 is shown. As a welding part it is made from a first component 4.1 and a second component 4.2, which are coupled to each other via a weld seam 11. As shown, for example, three part samples 12 are produced parallel and side-by-side by way of cutting. The part samples 12 are essentially configured in a rectangular form in a plan view and have a height H and width B. The weld seam 11 extends in the longitudinal direction L, the part samples 12 are cut out perpendicular in reference to the weld seam 11. The part samples 12 may however also be configured as shown in FIG. 3, for example, having a substantially semi-circular shape and configuration.

Then a cutaway 13 may remain in the part 4. A circumferential gap 14 develops between the cutaway 13 and the initially cut-out part sample 12. A breaking bar 15 remains in reference to the respective part sample 12 projecting beyond the face 16 of the part sample 12. Thus, the part sample 12 initially remains connected to the part 4. In the central part sample 12, shown in the image level, which is still located in the part, the breaking bar 15 is continuous and connected to the part. In the part sample 12, in reference to the image level at the right and the left, the breaking bar 15 is severed by breaking out the part sample 12 out of the part.

The part sample 12 at the right side of the image is seen in a plan view. The part sample 12 at the left side of the image is seen in a side view. The second component 4.2 overlaps here partially the first component 4.1 so that a first 4.1 and second 4.2 component in the upper section of the part sample 12 form a double-layer and are coupled to each other in a material-to-material fitting fashion via the weld seam 11. By water jet cutting here easily the double layer can be severed. At the right side of the image as well as on the part sample 12 in the part 4 lettering 17 is further shown, which is applied for example via laser marking on the part sample 12.

The lettering 17 is also applied at the other part samples 12, however here showing a different label number. In particular laser labeling offers the possibility to mark the part sample 12 with various data in a freely selected fashion.

Moreover, the method and the water jet according to the invention can easily sever wall thicknesses 18 ranging from 0.5 to 10 mm, or for example, from 1 to 3 mm or even a double layer area.

Referring now to FIG. 3, a cut-out part sample 12 having the external contour of a semi-circle and/or half-moon is illustrated. In this configuration, two different cut edges 19, 20 are generated. A straight cut edge 19 can be produced with high precision. This means that the feed rate of the water jet for the cutting process is here rather slow. This straight cut edge 19 can then be used to later perform the analysis of the part sample 12. A rounded cut edge 20, here performed in a semi-circular form, can however be produced with less precision and/or lower quality at the cut edge. This means, the feed rate of the water jet for cutting is particularly high. The quality at the cut edge itself requires no particularly high precision and serves only for severing the part sample 12 from the part.

Moreover, the breaking bar 15 is formed at the rounded cut edge 20, by which the part sample 12 initially remains connected to the part after the cutting process and can then be broken out. A weld seam, which extends for example perpendicular over the part sample 12, is not shown in greater detail. The semi-circle cut-out part sample 12 of FIG. 3 may be formed of a varying radius or extend over an angular range of less than or more than 180°.

Representative, non-limiting examples of the disclosure were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

### LIST OF REFERENCE CHARACTERS

1—Water jet cutting device
2—Protective panel
3—Technician
4.1—First part
4.2—Second part
5—Feed device
6—Industrial robot
7—Laser labeling device
8—Water jet cutting device
9—Water basin
10—Discharge device
11—Weld seam
12—Part sample
13—Cutaway
14—Gap
15—Breaking bar
16—Face of 12
17—Labeling
18—Wall thickness
19—Straight cut edge
20—Rounded cut edge
B—Width
H—Height
L—Longitudinal direction

1. A method for producing a part sample made from a metallic welded part, comprising:
providing the metallic welded part;
providing a water jet cutting device;
introducing the metallic part into the water jet cutting device;
water jet cutting a part sample section, which includes at least partially a weld seam, with the water jet cutting process being performed by sand being mixed in,
removing and visually inspecting the part sample as a metallurgic micrograph.

2. The method of claim 1, further comprising etching the part sample after the water jet cutting step.

3. The method of claim 2, further comprising generating a cutaway around the section of the part sample, forming a breaking bar extending from and attached to the part sample, wherein the part sample can be broken out of the welded part at a later point of time.

4. The method of claim 3, further comprising marking the part sample and/or the section of the part sample before or after the water jet cutting step.

5. The method of claim 4, further comprising providing an industrial robot in the water jet cutting device for accepting the welded part, moving the industrial robot inside the water jet cutting device, and guiding the industrial robot under the water jet.

6. The method of claim 5, further comprising providing a manipulator which moves the water jet for the water jet cutting process.

7. The method of claim 5, further comprising generating several part samples at a welded part parallel and next to each other.

8. The method of claim 7, wherein the weld seams extending in the longitudinal direction of the part sample perpendicular to the weld seam.

9. The method of claim 8, wherein the part sample is rectangular shaped in a plan view and has a dimension from 5 to 15 mm by 15 to 20 mm.

10. A method according to claim 3, wherein the breaking bar is formed at an upper face of the part sample and extends from a peripheral edge thereof.

11. The method of claim 4, wherein the marking is a laser marking.

12. The method of claim 9, wherein the part sample is dimensioned 5-15 mm by 10-20 mm.

13. The method of claim 9, wherein the part sample is has a semi-circular shape and configuration in a plan view.
